(19) United States
(12) Patent Application Publication
(10) Pub. No.: US 2024/0030602 A1
(43) Pub. Date: Jan. 25, 2024

(54) DUAL-BAND EXTERNAL ANTENNA FOR UNMANNED AERIAL VEHICLE AND UNMANNED AERIAL VEHICLE

(71) Applicant: AUTEL ROBOTICS CO., LTD., Shenzhen (CN)

(72) Inventors: Jianping SONG, Shenzhen (CN); Jianlei Wang, Shenzhen (CN)

(73) Assignee: AUTEL ROBOTICS CO., LTD., Shenzhen (CN)

(21) Appl. No.: 18/375,240

(22) Filed: Sep. 29, 2023

Related U.S. Application Data
(63) Continuation of application No. PCT/CN2022/079349, filed on Mar. 4, 2023.

(30) Foreign Application Priority Data
Mar. 30, 2021 (CN) 202110341249.9

(51) Int. Cl. H01Q 5/20; H01Q 5/335; H01Q 1/28; H01Q 1/50

(52) U.S. Cl. CPC H01Q 5/20; H01Q 5/335; H01Q 1/28; H01Q 1/50

(57) ABSTRACT

The present disclosure provides a dual-band external antenna for an unmanned aerial vehicle (UAV) and a UAV. The dual-band external antenna for the UAV includes a substrate, a low-frequency oscillator region, a high-frequency oscillator region, a feed coaxial line and ground terminals. Two ground terminals are respectively electrically connected to a feed terminal of the feed coaxial line. An avoidance region for arranging the feed coaxial line is disposed in the low-frequency oscillator region or the high-frequency oscillator region. The low-frequency oscillator region includes a first low-frequency oscillator region and a second low-frequency oscillator region. The high-frequency oscillator region includes a first high-frequency oscillator region and a second high-frequency oscillator region that are vertically asymmetrically disposed on the front and back sides of the substrate.

### CROSS-REFERENCE TO RELATED APPLICATIONS

The present application is a Continuation application of International Application No. PCT/CN2022/079349, filed on Mar. 4, 2022, which claims the benefit of priority to Chinese Patent Application No. 2021103412499, filed on Mar. 30, 2021, the contents of both of which are incorporated herein by reference in their entirety for all purposes.

### TECHNICAL FIELD

The present disclosure relates to the field of unmanned aerial vehicle (UAV) technologies, and in particular, to a dual-band external antenna for a UAV and a UAV.

### BACKGROUND

With the fast development of wireless communication, based on requirements of various data services, antenna design is mainly developed towards miniaturization, multi-band and wideband. A microstrip antenna is more and more widely used due to advantages of a compact structure, a small size, a light weight and easiness of being integrated with a microstrip line. The microstrip antenna is an antenna formed by sticking a conductor patch on a dielectric substrate with a ground plate. An electromagnetic field is excited between the conductor patch and the ground plate by using a coaxial line to feed electricity. The electromagnetic field radiates to the outside through a slot.

An existing dual-band external antenna for a UAV is usually disposed in a landing skid and is usually a microstrip antenna at 2.4 GHz and 5.8 GHz. A microstrip antenna operating at a low-frequency band (such as a microstrip antenna at 900 Hz) is large in size and cannot be mounted in the landing skid due to size limitation of the landing skid. An arm of a UAV has a space size larger than that of the landing skid of the UAV. However, an environment of the arm of the UAV is complex and is intended to affect a communication signal of the antenna.

Therefore, for a person skilled in the art, a dual-band external antenna for a UAV that can resolve both a problem of the space size and a problem of environment interference is urgently to be implemented.

### SUMMARY

An objective of the present disclosure is to provide a dual-band external antenna for a UAV. The dual-band external antenna for a UAV has a proper layout and can implement dual-band signal coverage.

To achieve the above objective, the following technical solutions are adopted in the present disclosure:

A dual-band external antenna for UAV is provided, including:
a substrate, a low-frequency oscillator region and a high-frequency oscillator region that are disposed on front and back sides of the substrate, a feed coaxial line electrically connected to the low-frequency oscillator region and the high-frequency oscillator region and ground terminals disposed on the front and back sides of the substrate. Two ground terminals are respectively electrically connected to a feed terminal of the feed coaxial line.

An avoidance region for arranging the feed coaxial line is disposed in the low-frequency oscillator region or the high-frequency oscillator region.

The low-frequency oscillator region includes a first low-frequency oscillator region and a second low-frequency oscillator region that are vertically asymmetrically disposed on the front and back sides of the substrate.

The high-frequency oscillator region includes a first high-frequency oscillator region and a second high-frequency oscillator region that are vertically asymmetrically disposed on the front and back sides of the substrate.

Both the first low-frequency oscillator region and the first high-frequency oscillator region are disposed on the front side of the substrate and are spaced apart along a length direction of the substrate.

Both the second low-frequency oscillator region and the second high-frequency oscillator region are disposed on the back side of the substrate and are spaced apart along a length direction of the substrate.

The first low-frequency oscillator region and the first high-frequency oscillator region each include a first microstrip feeder and a second microstrip feeder that are electrically connected to each other, a clearance slot being opened between the first microstrip feeder and the second microstrip feeder.

Two second microstrip feeders are disposed and respectively located on two sides of the first microstrip feeder, a sum of areas of the two second microstrip feeders being smaller than a total area of the first microstrip feeder.

The second low-frequency oscillator region and the second high-frequency oscillator region each include a third microstrip feeder and a fourth microstrip feeder that are electrically connected to each other, the clearance slot being opened between the third microstrip feeder and the fourth microstrip feeder.

Two fourth microstrip feeders are both located on a same side of two third microstrip feeders.

A mapping sheet is further disposed on aside of each of the second low-frequency oscillator region and the second high-frequency oscillator region away from two third microstrip feeders, the clearance slot being opened between the mapping sheet and the third microstrip feeder.

A surface area of the third microstrip feeder is greater than a surface area of the fourth microstrip feeder.

A UAV is provided, including the foregoing dual-band external antenna for a UAV, a landing skid sleeved on the dual-band external antenna for a UAV and an arm matching the landing skid.

Beneficial effects of the present disclosure are as follows: The present disclosure discloses a dual-band external antenna for a UAV, including a substrate, a low-frequency oscillator region and a high-frequency oscillator region that are disposed on front and back sides of the substrate, a feed coaxial line electrically connected to the low-frequency oscillator region and the high-frequency oscillator region and ground terminals disposed on the front and back sides of the substrate. Two ground terminals are respectively electrically connected to a feed terminal of the feed coaxial line. An avoidance region for arranging the feed coaxial line is disposed in the low-frequency oscillator region or the high-frequency oscillator region. The low-frequency oscillator region includes a first low-frequency oscillator region and a second low-frequency oscillator region that are vertically asymmetrically disposed on the front and back sides of the substrate. The high-frequency oscillator region includes a first high-frequency oscillator region and a second high-frequency oscillator region that are vertically asymmetrically disposed on the front and back sides of the substrate. In the dual-band external antenna for a UAV that is designed with this structure, the first low-frequency oscillator region and the second low-frequency oscillator region, as well as the first high-frequency oscillator region and the second high-frequency oscillator region, are asymmetrically disposed on the front and back sides, to meet routing requirements in small space. In this way, the line layout is more proper, and dual-band signal coverage can be additionally implemented.

### BRIEF DESCRIPTION OF THE DRAWINGS

FIG. 1 is a front line layout diagram of a dual-band external antenna for a UAV according to an embodiment;

FIG. 2 is a back line layout diagram of a dual-band external antenna for a UAV according to an embodiment;

FIG. 3 is a schematic diagram of scattering parameters of a dual-band external antenna for a UAV according to an embodiment;

FIG. 4 is an antenna direction diagram of a dual-band external antenna for a UAV at a 2.4 GHz band according to an embodiment;

FIG. 5 is an antenna direction diagram of a dual-band external antenna for a UAV at a 5.8 GHz band according to an embodiment; and

FIG. 6 is an axonometric diagram obtained after an arm and a landing skid of a UAV and a dual-band external antenna for a UAV according to an embodiment are assembled.

### DESCRIPTIONS OF REFERENCE NUMERALS

1. substrate;
21. first low-frequency oscillator region; 211. first microstrip feeder; 2111. avoidance region; 212. second microstrip feeder; 213. clearance slot; 22. second low-frequency oscillator region; 221. third microstrip feeder; 222. fourth microstrip feeder; 223. mapping sheet;
31. first high-frequency oscillator region; 32. second high-frequency oscillator region;
4. feed coaxial line; 5. ground terminal; 6. foam; 7. landing skid; and 8. arm.

### DETAILED DESCRIPTION

The following further describes the present disclosure in detail with reference to the accompanying drawings and embodiments. It may be understood that specific embodiments described herein are merely used to explain the present disclosure, but not to limit the present disclosure. In addition, it should be further noted that, for ease of description, the accompanying drawings only show parts relevant to the present disclosure rather than an entire structure.

In the description of the present disclosure, unless otherwise explicitly specified or limited, the terms “connected”, “connection” and “fixed” should be understood broadly. For example, a connection may be a fixed connection, a detachable connection or an integral connection; the connection may be a mechanical connection or an electrical connection; or the connection may be a direct connection, an indirect connection through an intermediate, or internal communication between two elements or an interaction relationship between two elements. A person of ordinary skill in the art may understand the specific meanings of the foregoing terms in the present disclosure according to specific situations.

In the present disclosure, unless otherwise explicitly specified and defined, a first feature being “over” or “below” a second feature may mean that the first feature and the second feature are in direct contact, or the first feature and the second feature are not in direct contact but are in contact through another feature therebetween. Moreover, the first feature being “over”, “above” and “on” the second feature means that the first feature is directly above or obliquely above the second feature, or merely means that a horizontal height of the first feature is higher than that of the second feature. The first feature being “below” the second feature means that the first feature is directly below the second feature or is obliquely below the second feature, or merely means that a horizontal height of the first feature is lower than that of the second feature.

In the description of the embodiments, orientation or position relationships indicated by the terms such as “upper”, “lower” and “right” are based on orientation or position relationships shown in the accompanying drawings and are used only for ease of description and simplifying operations, rather than indicating or implying that the mentioned apparatus or component needs to have a particular orientation or needs to be constructed and operated in a particular orientation. Therefore, such terms should not be construed as limitation of the present disclosure. In addition, the terms “first” and “second” are merely used for distinction in description and have no specific meanings.

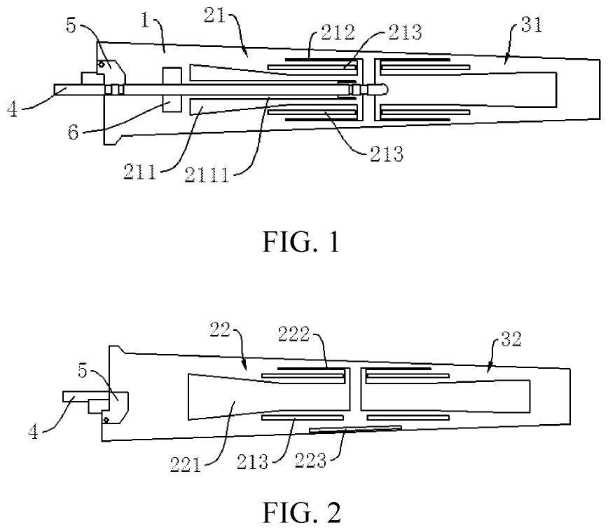

FIG. 1 is a front diagram of a dual-band external antenna for a UAV according to one embodiment. FIG. 2 is a back diagram of the dual-band external antenna for a UAV according to one embodiment. With reference to FIG. 1 and FIG. 2, the dual-band external antenna for a UAV provided in one embodiment includes several parts of a substrate 1, a low-frequency oscillator region, a high-frequency oscillator region, a feed coaxial line 4 and ground terminals 5.

Specifically, the substrate 1 is preferably a double-side board made of an FR-4 material. (FR-4 is a code name of a flame-resistant material grade, which means a material specification requiring a resin material to automatically extinguish after being burned. FR-4 is a material grade rather than a material name. Therefore, there are many types of FR-4 grade materials currently used in common circuit boards, but most are composite materials made of so-called Tera-Function epoxy resin, fillers and glass fiber.) The low-frequency oscillator region, the high-frequency oscillator region and the ground terminals 5 are separately disposed on front and back sides of the substrate 1 through a copper laminate cladding on the substrate 1. In this way, the line layout is more proper and more compact while parameters of the dual-band external antenna for a UAV are met, so that utilization of the substrate 1 is improved.

Further, the low-frequency oscillator region in one embodiment includes a first low-frequency oscillator region 21 and a second low-frequency oscillator region 22 that are vertically asymmetrically disposed on the front and back sides of the substrate 1. The high-frequency oscillator region includes a first high-frequency oscillator region 31 and a second high-frequency oscillator region 32 that are vertically asymmetrically disposed on the front and back sides of the substrate 1. Preferably, in one embodiment, both the first low-frequency oscillator region 21 and the first high-frequency oscillator region 31 are disposed on the front side of the substrate 1 and are spaced apart along a length direction of the substrate 1. Line layout structures of the first low-frequency oscillator region 21 and the first high-frequency oscillator region 31 after being routed in this layout manner are basically the same and represent a layout of a shape of the Chinese character “ [symbol] ”. The first low-frequency oscillator region 21 and the first high-frequency oscillator region 31 each include a first microstrip feeder 211 and a second microstrip feeder 212 that are electrically connected to each other, a clearance slot 213 being opened between the first microstrip feeder 211 and the second microstrip feeder 212. With reference to FIG. 1, the first low-frequency oscillator region 21 and the first high-frequency oscillator region 31 after routing are disposed symmetrically along a cross section of the substrate 1 except for two first microstrip feeders 211 in asymmetrical shapes.

In one embodiment, the foregoing line layout is further described by using an example of a layout of the first low-frequency oscillator region 21. The first microstrip feeder 211 are disposed on the first low-frequency oscillator region 21 along a length direction of the middle of the substrate 1. A total area of the first microstrip feeder 211 is larger than a sum of areas of two second microstrip feeders 212 routed on two sides of the first microstrip feeder 211. The clearance slot 213 is disposed between each of the two second microstrip feeders 212 and the first microstrip feeder. A total length of the first microstrip feeder 211 is 2.2-2.5 times longer than a length of the second microstrip feeder 212. In this way, capacitor features formed by the first microstrip feeder 211 and the second microstrip feeder 212 is improved to further improve signal coverage.

Further, in one embodiment, for convenience of arranging the feed coaxial linefeed coaxial line 4 and reducing impact of the feed coaxial line 4 on the low-frequency oscillator region and the high-frequency oscillator region, an avoidance region 2111 is preferably disposed on the first low-frequency oscillator region 21 along a length direction of the substrate 1 in one embodiment. The feed coaxial line 4 is disposed along the avoidance region 2111. To expand a gap between the feed coaxial line 4 and the substrate 1 below, effectively reduce impact of signal transmission on resonance waves and facilitate fixing of the feed coaxial line 4, a foam 6 is further disposed between the feed coaxial line 4 and the substrate 1. A feed terminal of the feed coaxial line 4 routed in this manner, that is, a tail portion of the feed coaxial line 4, is electrically connected to the two ground terminals 5 that are disposed on the front and back sides of the substrate 1. Preferably, an inner conductor in a head portion of the feed coaxial line 4 is electrically connected to the low-frequency oscillator region, and an external conductor is electrically connected to the high-frequency oscillator region.

Further, in one embodiment, both the second low-frequency oscillator region 22 and the second high-frequency oscillator region 32 are disposed on the back side of the substrate 1 and are also spaced apart along the length direction of the substrate 1. Layout structures of the second low-frequency oscillator region 22 and the second high-frequency oscillator region 32 are basically the same. The second low-frequency oscillator region 22 and the second high-frequency oscillator region 32 each include a third microstrip feeder 221 and a fourth microstrip feeder 222 that are electrically connected to each other, the clearance slot 213 being opened between the third microstrip feeder 221 and the fourth microstrip feeder 222. Two fourth microstrip feeders 222 are both located on a same side of two third microstrip feeders 221.

In one embodiment, the second low-frequency oscillator region 22 is used as an example. Preferably, the fourth microstrip feeder 222 is routed on a side of the third microstrip feeder 221. The third microstrip feeder 221 and the fourth microstrip feeder 222 share the clearance slot 213. In addition, a mapping sheet 223 is further disposed on a side of the third microstrip feeder 221 away from the fourth microstrip feeder 222. A clearance slot 213 is opened between the mapping sheet 223 and the third microstrip feeder 221. A surface area of the third microstrip feeder 221 routed in this manner is greater than a surface area of the fourth microstrip feeder 222. With reference to FIG. 2, the second low-frequency oscillator region 22 and the second high-frequency oscillator region 32 after being routed in the foregoing manner are disposed symmetrically along the cross section of the substrate 1 except for two third microstrip feeders 221 in asymmetrical shapes.

In addition, in the foregoing embodiment, the second low-frequency oscillator region 22 is preferably formed by mirroring the first low-frequency oscillator region 21. Compared with the line layout of the first low-frequency oscillator region 21, the second low-frequency oscillator region 22 has one less second microstrip feeder 212. Similarly, the second high-frequency oscillator region 32 is formed by mirroring the first high-frequency oscillator region 31. Compared with a line layout of the first high-frequency oscillator region 31, the second high-frequency oscillator region 32 also has one less second microstrip feeder 212.

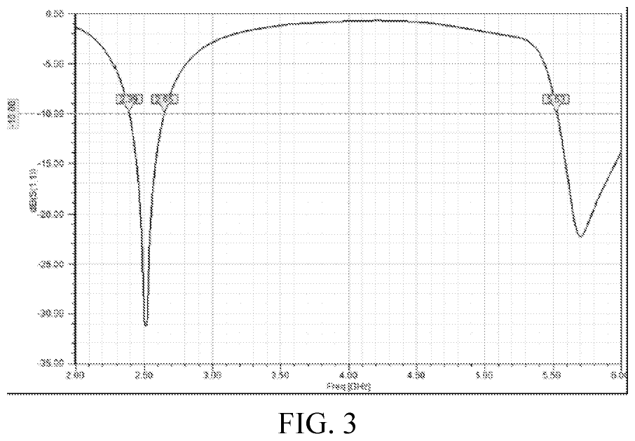

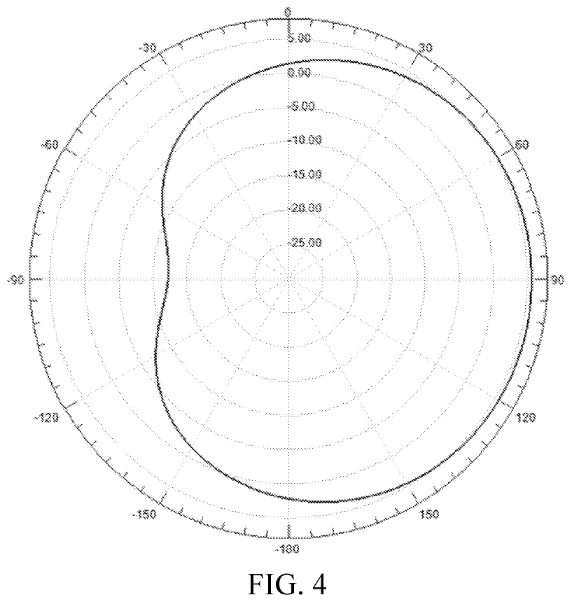

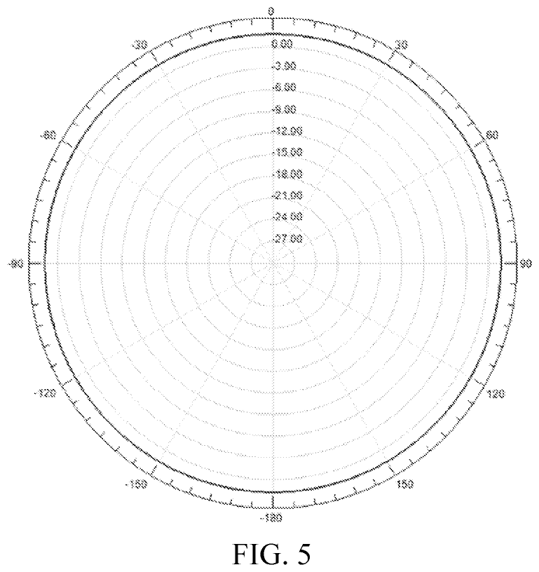

The dual-band external antenna for a UAV that is provided by adopting the foregoing structure can resolve a problem of routing difficulty due to size limitation of a landing skid 7 in the prior art. In addition, the line after routing can implement dual-band signal coverage at 2.4 GHz and 5.8 GHz to a maximum extend. FIG. 3, FIG. 4 and FIG. 5 are schematic diagrams of scattering parameters and antenna direction diagrams of a tested antenna operating at two bands of 2.39 GHz to 2.65 GHz and 5.53 GHz to 6 GHz.

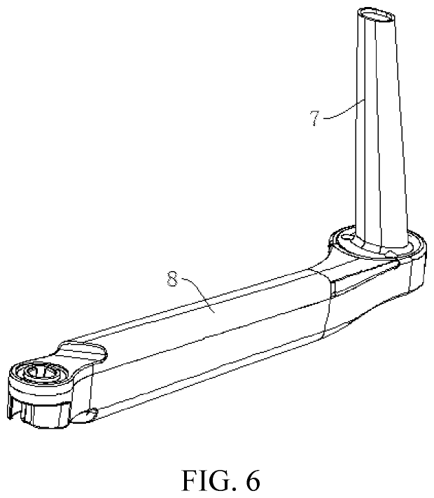

In addition, with reference to FIG. 6, an embodiment further provides a UAV. The UAV includes the foregoing dual-band external antenna for a UAV, a landing skid 7 sleeved on the dual-band external antenna for a UAV and an arm 8 matching the landing skid 7. For a UAV adopting the foregoing dual-band external antenna for a UAV, the UAV can effectively implement, by using the the dual-band external antenna for a UAV, dual-band signal coverage of the UAV in a case of limiting space of the landing skid 7.

It should be noted that the foregoing descriptions are merely preferred embodiments of the present disclosure and the technical principles used. A person skilled in the art should understand that the present disclosure is not limited to the specific embodiments herein. A person skilled in the art can perform various apparent changes, readjustments and replacements without departing from the protection scope of the present disclosure. Therefore, although the present disclosure is described in detail by using the foregoing embodiments, the present disclosure is not merely limited to the foregoing embodiments and may include more other equivalent embodiments without departing from the conception of the present disclosure. The scope of the present disclosure depends on the scope of the appended claims.

What is claimed is:

1. A dual-band external antenna for an unmanned aerial vehicle (UAV), comprising a substrate, a low-frequency oscillator region and a high-frequency oscillator region disposed on front and back sides of the substrate, a feed coaxial line electrically connected to the low-frequency oscillator region and the high-frequency oscillator region, and ground terminals disposed on the front and back sides of the substrate, wherein:
two ground terminals are respectively electrically connected to a feed terminal of the feed coaxial line;
an avoidance region for disposing the feed coaxial line is disposed in the low-frequency oscillator region or the high-frequency oscillator region;
the low-frequency oscillator region comprises:
a first low-frequency oscillator region and a second low-frequency oscillator region, vertically asymmetrically disposed on the front and back sides of the substrate; and
the high-frequency oscillator region comprises:
a first high-frequency oscillator region and a second high-frequency oscillator region, vertically asymmetrically disposed on the front and back sides of the substrate.

2. The dual-band external antenna for the UAV according to claim 1, wherein both the first low-frequency oscillator region and the first high-frequency oscillator region are disposed on the front side of the substrate and are spaced apart along a length direction of the substrate.

3. The dual-band external antenna for the UAV according to claim 1, wherein both the second low-frequency oscillator region and the second high-frequency oscillator region are disposed on the back side of the substrate and are spaced apart along a length direction of the substrate.

4. The dual-band external antenna for the UAV according to claim 1, wherein the first low-frequency oscillator region and the first high-frequency oscillator region both comprise a first microstrip feeder and a second microstrip feeder, the first microstrip feeder and the second microstrip feeder are electrically connected, and a clearance slot is opened between the first microstrip feeder and the second microstrip feeder.

5. The dual-band external antenna for the UAV according to claim 4, wherein two second microstrip feeders are provided, the two second microstrip feeders are respectively located on two sides of the first microstrip feeder, and a sum of areas of the two second microstrip feeders is smaller than a total area of the first microstrip feeder.

6. The dual-band external antenna for the UAV according to claim 4, wherein the second low-frequency oscillator region and the second high-frequency oscillator region both comprise a third microstrip feeder and a fourth microstrip feeder, the third microstrip feeder and the fourth microstrip feeder are electrically connected, and the clearance slot is opened between the third microstrip feeder and the fourth microstrip feeder.

7. The dual-band external antenna for the UAV according to claim 6, wherein two fourth microstrip feeders are both located on a same side of two third microstrip feeders.

8. The dual-band external antenna for the UAV according to claim 6, wherein a mapping sheet is further disposed on a side of the second low-frequency oscillator region and the second high-frequency oscillator region away from two third microstrip feeders, and the clearance slot is opened between the mapping sheet and the third microstrip feeder.

9. The dual-band external antenna for the UAV according to claim 8, wherein a surface area of the third microstrip feeder is greater than a surface area of the fourth microstrip feeder.

10. A UAV, comprising: the dual-band external antenna according to claim 1, a landing skid sleeved on the dual-band external antenna, and an arm matching the landing skid.
